(19) United States
(12) Patent Application Publication
(10) Pub. No.: US 2020/0190895 A1
(43) Pub. Date: Jun. 18, 2020

(54) Balcony Inspection Vent

(71) Applicants: Alan Wilson, San Diego, CA (US); James Weber, San Diego, CA (US)

(72) Inventors: Alan Wilson, San Diego, CA (US); James Weber, San Diego, CA (US)

(21) Appl. No.: 16/715,879

(22) Filed: Dec. 16, 2019

Related U.S. Application Data
(60) Provisional application No. 62/780,016, filed on Dec. 14, 2018.

(51) Int. Cl. E06B 5/00; E04B 1/00

(52) U.S. Cl. CPC E06B 5/00; E04B 1/003

(57) ABSTRACT

A balcony inspection vent system provides an easily accessible port for inspecting balconies in multifamily residential and commercial buildings. The balcony inspection vent is configured to be installed on the underside of a balcony between the several structural joists supporting the balconies allowing access to the open stud bays for inspecting the structural integrity of the balcony. The balcony inspection vent system consists of a metal frame fixed to the structural joists using threaded fasteners. The frame includes a stucco retaining edge for concealing the frame within the balcony surface. The balcony inspection vent system consists of a hinged access door having a mesh screen to allow easy ventilation to the underside of the balcony. The hinged access door is attached to the vent frame on one side, and the other side of the door is free and openable using a handle (latch), allowing inspection of the underlying structural components.

### RELATED APPLICATION

This application claims priority to U.S. Provisional Patent Application Ser. No. 62/780,016 for a “Balcony Inspection Vent,” filed Dec. 14, 2018, and currently co-pending, the entirety of which is incorporated herein by reference.

### FIELD OF THE INVENTION

The present invention relates to a vent system for inspecting the structural integrity of the balcony support structure. More specifically, the present invention is intended to provide an accessible port for inspecting balconies in multifamily residential and commercial buildings.

### BACKGROUND OF THE INVENTION

There are approximately 40 million existing decks and balconies in the United States, among which only one-half complies with the current building codes. Construction experts strongly believe that many of these decks and balconies are potentially unsafe. The International Code Council (ICC), a membership organization dedicated to building safety and fire prevention suggests residential and commercial buildings to conduct a periodic inspection of their decks, balconies and porches. Most U.S. cities, counties and states adopt their building codes based on the International Codes developed by the ICC. Failure to periodically inspect balcony assemblies has often led to catastrophic consequences. For example, the infamous Berkeley balcony collapse in 2015 provided overwhelming evidence pointing to the failure to inspect the balcony support structure as one of the major causes for the collapse. After this deadly incident, various cities in the United States have enacted new building codes, requiring all residential and commercial buildings with elevated exterior elements, such as balconies, decks and walkways to be inspected on a regular basis.

A standard visual balcony inspection for evaluating the safety and integrity of a balcony structure is both time-consuming and insufficient. The current procedure for balcony inspection involves an expert checking the framing structures that are deeply buried within stucco assemblies. This procedure is cumbersome and often won't reveal sufficient information about the structural integrity of components that lies beneath a concealed balcony. In most cases, an expert would necessitate removing a strip of stucco parallel to the building's wall on the entire underside of the balcony, which would provide enough room for a person to stick his head through the opening to examine the connection to the building. After the expert examines the underlying framing structure, the stucco has to be patched in order to retain its original texture. The above procedure is often associated with significant increased time, expense, and inconvenience for the property owners, particularly for larger multifamily residential and commercial buildings. With the increasing amount of regulations governing the structural integrity of balconies, the above procedure poses significant burden on the property owners.

Flooding on balconies is a regular occurrence when drains overflow during periods of rainfall or in case of inadequate sloping of the balcony. Over time, flooding on balconies may cause severe damages to the structural components of the balcony. In most instances, this damage occurs due to construction deficiencies and subsequent water intrusion causing deterioration, corrosion and rot on the existing structural components. There are many steps that can be followed to prevent water intrusion in balconies including sloping, flashing, wood trim and sealants. However, there is no realistic system that can directly eliminate trapped water or absorbed moisture retained within the balcony structure.

In light of the above, it would be advantageous to provide a simple way to inspect the internal structure of a balcony. It would be further advantageous to provide a way to inspect a balcony without removing stucco. It would be further advantageous to provide a system for eliminating trapped moisture within a balcony structure.

### SUMMARY OF THE INVENTION

The present invention provides a vent system for inspecting balconies in multifamily residential and commercial buildings. The present invention offers a port for inspecting the structural integrity of the balcony support structure.

The present invention includes a vent system, which is configured to be installed on the underside a balcony between the structural joists supporting the balconies allowing access to the open stud bays for inspecting the structural integrity of the balcony.

The balcony inspection vent system has a metal frame (frame) made of aluminum and steel, which is fixed to the structural joists using a threaded fastener including nails, nuts, screws and bolts. The frame holds the vent system below the surface of the balcony allowing easy access to the structural components of the balcony. The frame can be constructed in multiple sizes, allowing it to be made in a size consistent with the size of the balcony. In a preferred embodiment, the frame consists of a horizontal rod molded to a t-shaped rod on the right and left hand side corners of the rod. The t-shaped rod consists of a small hole on both of its ends for attaching the frame to the supporting joists of the balcony using a threaded fastener. The frame further includes a stucco retaining edge for applying the stucco to conceal the frame within the balcony surface.

The balcony inspection vent system has a hinged access door (faceplate), which is attached to the anterior surface of the frame enabling free movement of the door to the outside. The faceplate can be constructed in multiple sizes consistent with the size of the frame. In a preferred embodiment, the hinged access door will be rectangular in shape modeled to fit the size of a particular frame. The faceplate has a screen/mesh on its surface, which allows free circulation of air into the vent system. The mesh further serves to release absorbed moisture that is retained within the balcony structure and thereby preventing long-term structural damage to the balcony. In another preferred embodiment, the frame may be sealed with a sealant to prevent bees, wasps, termites and insects from entering the vent system. The faceplate is attached to the frame on one side, and the other side of the faceplate is free and openable attached to a handle (latch), which may include a lever, magnet or a lock and key device. The handle is provided on both the ends of the door on its outer surface enabling easy access for a user.

In another preferred embodiment, the balcony inspection vent system has a circular face plate secured to the underside of the balcony with a toggle screw lock. Engagement of the toggle screw lock to open the lock allows for removal of the faceplate for inspection of the internal structure of the balcony or other actions for which access to the internal portion of the balcony may be useful. After inspection or another desired action for which the face plate was removed, the face plate is replaced and secured to the balcony through engagement of the toggle screw lock to place the lock in a closed configuration.

### BRIEF DESCRIPTION OF THE DRAWINGS

The nature, object, and advantages of the present invention will become more apparent to those skilled in the art after considering the following detailed description in connection with the accompanying drawings, in which like reference numerals designate like parts throughout, and wherein:

FIG. 1 is a front view of a preferred embodiment a balcony inspection vent system of the present invention showing the vent system in an open configuration;

FIG. 2 is a front view of the balcony inspection vent system, showing the attachment of balcony inspection vent system to the supporting joists of the balcony;

FIG. 3 is a diagram of a part of the balcony inspection vent system, showing the molded t-shaped rod attached to both sides of the frame;

FIG. 4 is a diagram of a preferred embodiment of the balcony inspection vent system of the present invention showing the balcony inspection vent system in a closed configuration;

FIG. 5 is a sectional view of the balcony inspection vent system taken along line A-A of FIG. 4 and illustrating the balcony inspection vent system in its closed configuration;

FIG. 6 is a diagram of a preferred embodiment of the balcony inspection vent system of the present invention showing the balcony inspection vent system in an open configuration;

FIG. 7 is a sectional view of the balcony inspection vent system taken along line B-B of FIG. 6 and illustrating the balcony inspection vent system in its open configuration;

FIG. 8 is a perspective view of a preferred embodiment of a balcony inspection vent system of the present invention fixed to the underside of a balcony and in its closed configuration;

FIG. 9 is a perspective view of a preferred embodiment of a balcony inspection vent system of the present invention fixed to the underside of a balcony and in its open configuration;

FIG. 10 is a front view of a preferred embodiment of a balcony inspection vent system of the present invention showing balcony inspection vent door sealed with a sealant;

FIG. 11 is a plan view of an alternative preferred embodiment of a balcony inspection vent system of the present invention showing a circular vent inspection port;

FIG. 12 is a sectional view of a balcony inspection vent system of the present invention showing a toggle screw lock for securing a vent door to a balcony, with the toggle screw lock in an unsecured configuration;

FIG. 13 is a sectional view of a balcony inspection vent system as shown in FIG. 12, with the toggle screw lock in a secured configuration;

FIG. 14 is a plan view of preferred embodiment of a balcony inspection vent system showing a circular vent inspection port;

FIG. 15 is a sectional view of a balcony inspection vent system showing a toggle screw lock for securing a vent door to a balcony, with the toggle screw lock in an unsecured configuration; and

FIG. 16 is a sectional view of a balcony inspection vent system showing a toggle screw lock for securing a vent door to a balcony, with the toggle screw lock in a secured configuration.

### DETAILED DESCRIPTION OF A PREFERRED EMBODIMENT

The present invention provides a balcony inspection vent system for inspecting the structural integrity of the balcony support structure in multifamily residential and commercial buildings.

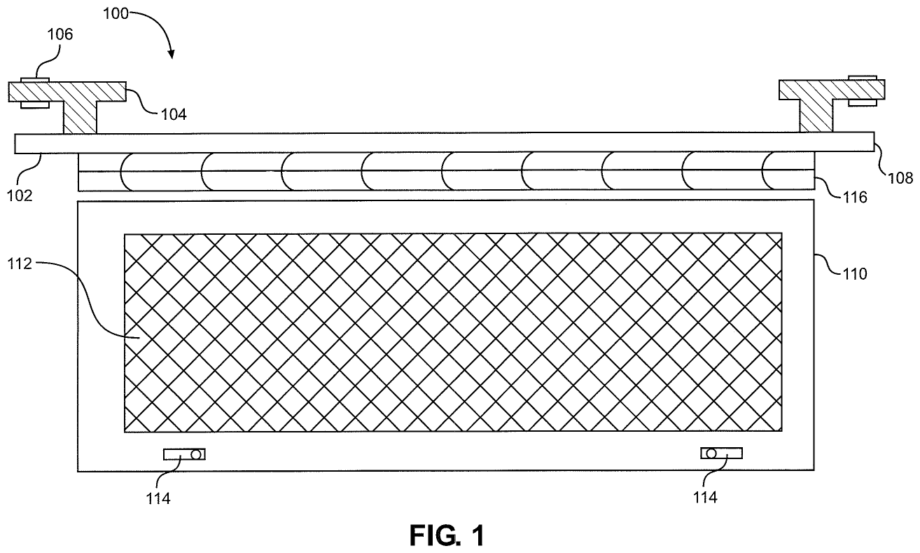

Referring initially to FIG. 1, a balcony inspection vent system is shown and generally designated 100. The balcony inspection vent system 100 has a frame 102, which includes the t-shaped rod 104, stucco-retaining edge 108, vent door 110 and hinge 116 as described more fully below. The balcony inspection vent system 100 has a frame 102 that includes a horizontal rod made of aluminum and steel, which can be made in different sizes to fit the size of the balcony. The frame 102 has a molded t-shaped rod 104 attached to each side of the frame. The t-shaped rod 104 has fastening grooves 106, which enable the attachment of the frame 102 to the balcony. The frame 102 also has a stucco-retaining edge 108 on both sides for applying the stucco to conceal the frame 102 within the balcony surface. A vent door 110 (or faceplate) is attached to the frame 102 with a hinge 116. The hinge 116 enables free outward opening of the vent door 110 while inspecting the balcony support structure. The vent door 110 has a screen 112, which, in a preferred embodiment is a mesh screen allowing free circulation of air into the vent system. The mesh screen 112 further serves to release absorbed moisture that is retained within the balcony structure due to flooding and/or inadequate sloping of the balcony. The mesh screen 112 helps to prevent long-term structural damage to the balcony. The vent door 110 can be constructed in multiple sizes to fit the size of the balcony. In a preferred embodiment, the vent door 110 is rectangular in shape consistent with the size of the balcony. In a preferred embodiment, the vent door 110 is made of aluminum and steel as similar to the rest of the frame 102. The vent door 110 has at least one latch, or handle 114, which includes a lever, magnet, a lock and key device, or other apparatus for maintaining the vent system 100 in its closed configuration when not in use. As seen in FIG. 1, a preferred embodiment of the vent door has two handles 114 opposite each other, and both opposite the hinge 116. The handle 114 helps to secure the vent door 110 in a closed position when the vent system 100 is not in use.

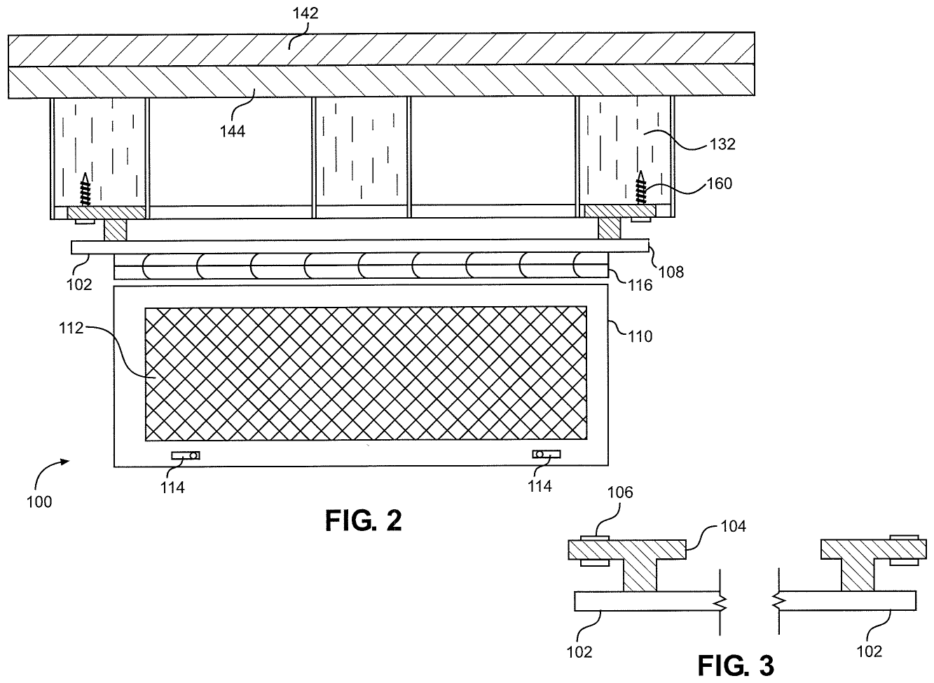

Referring now to FIG. 2, the balcony inspection vent system 100 is shown attached to the supporting joists 132 of the balcony. In a typical balcony construction, the floor joists inside the home are extended outside, beyond the walls of the house, to support the balcony floor 142. The balcony subfloor 144 is the decking installed on top of flooring joists; then the finished balcony floor 142 is installed on top of the subfloor 144. The supporting joists 132 cantilever out beyond the walls to support the balcony. The frame 102 is attached to the supporting joists 132 of the balcony using fastener 160. In preferred embodiments, fastener 160 is threaded, and nuts, screws, bolts, or other fasteners may be used. Although threaded fasteners are preferred for strength and pullout resistance, it is fully contemplated that non-threaded fasteners known in the art, such as nails, may also be used. The frame 102 comprises a molded t-shaped rod 104 on both sides. The t-shaped rod 104 includes fastening grooves 106, which allows a threaded fastener 160 to attach the frame 102 to the supporting joists 132 of the balcony. The stucco-retaining edge 108 further helps in attaching the frame to the balcony and conceals the frame within the balcony surface. The balcony inspection vent system 100 will allow access to the open stud bays 130 for inspecting the structural integrity of the balcony support structure.

Referring now to FIG. 3, the molded t-shaped rods have fastening grooves 106 for attaching the frame 102 to the supporting joists 132 of the balcony. The fastening grooves 106 allow the motion of a threaded fastener through it while attaching the frame 102 to the balcony support structure.

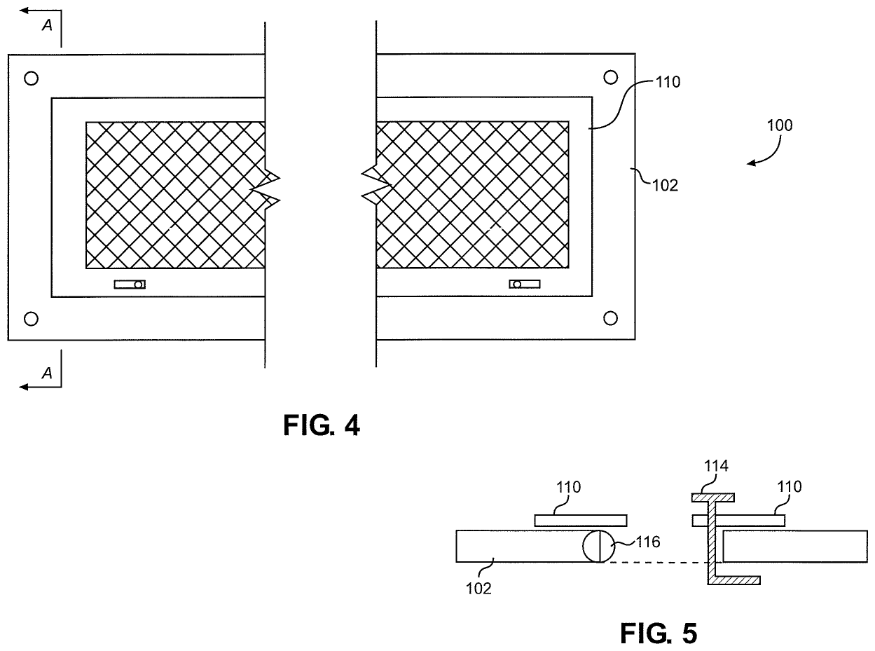

Referring now to FIG. 4, the balcony inspection vent system 100 is shown in a closed configuration, in which the balcony vent door 110 is flush in line with underside of the balcony, hiding the appearance of the vent door 110 along the balcony surface.

FIG. 5, taken along Section A-A of FIG. 4, demonstrates the closed position of the vent door 110, which can be custom-made to perfectly suit the thickness of a balcony for a flush finish.

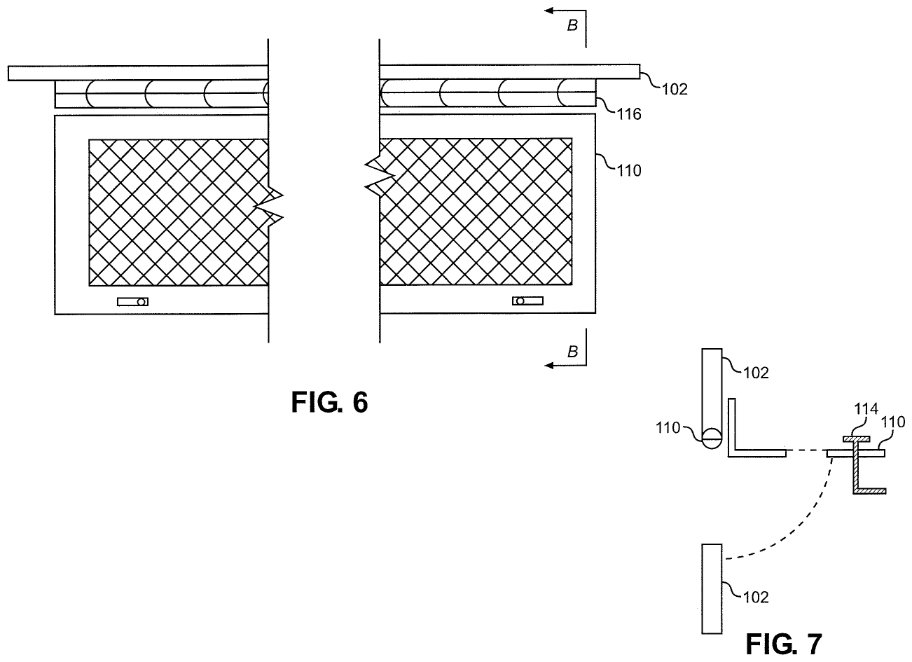

Referring now to FIG. 6, the balcony inspection vent system 100 is shown in an open configuration, in which the balcony vent door 110 is positioned to hang vertically hinged to the frame against the wall. The handle 114 is released to enable the outward opening of the vent door 110.

FIG. 7, taken along Section B-B of FIG. 6, demonstrates the open position of the balcony inspection vent system 100 with the vent door 110 opening to its outside, which facilitates a viewing port 150 for the user to inspect the structural integrity of the balcony.

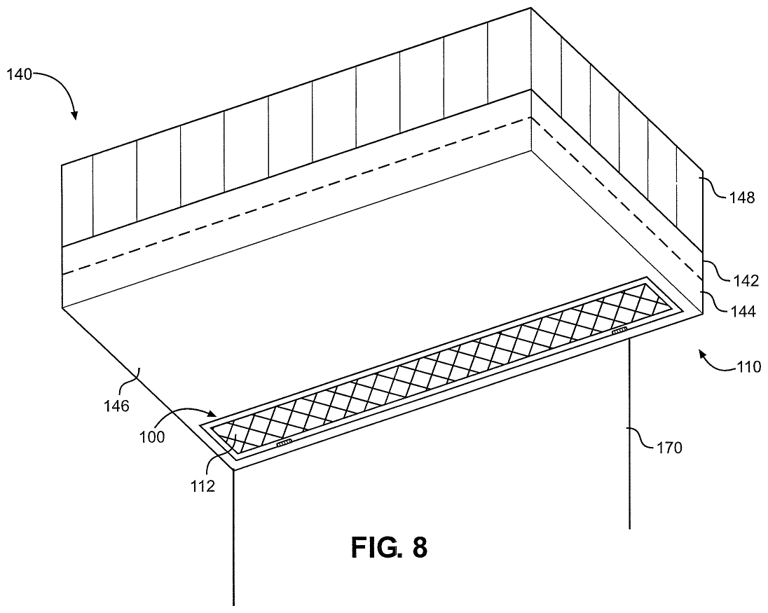

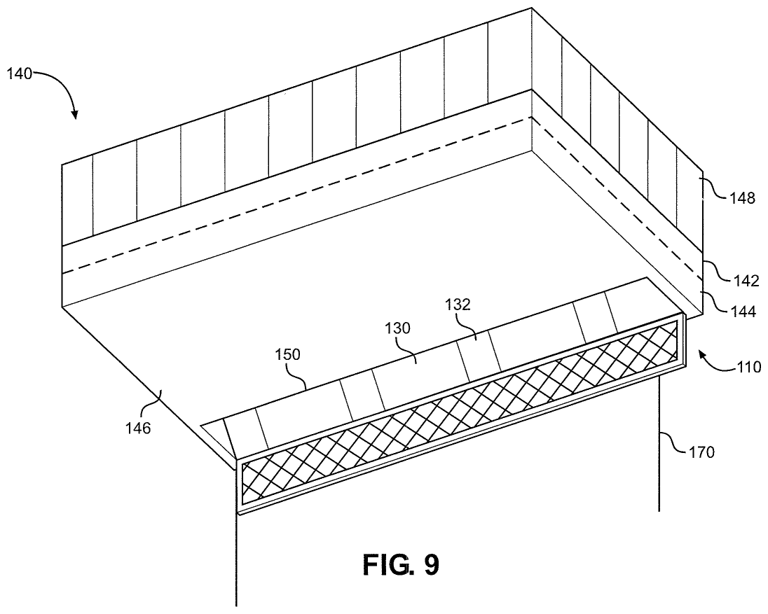

Referring now to FIG. 8, the balcony inspection vent system 100 is shown fixed to the underside 146 of the balcony 140. A typical balcony 140 consists of a balcony floor 142 on its dorsal surface, a sub-floor 144, which lies intermediate and an underside 146 on its ventral surface. The balcony 140 is often supported by concealed joists that extend beyond the walls 170 of the house. The balcony inspection vent system 100 is fixed parallel to one side of the longer edge of the balcony 140 extending lengthwise across the entire surface of the balcony. The balcony inspection vent system 100 is often fixed to the edge that is adjacent to the wall 170. This provision enables the vent door 110 to lean against the wall 170 in its open position (as shown in FIG. 9) enabling the user to access the open stud bays 130 and supporting joists 132 of the balcony 140.

Referring now to FIG. 9, in its open position, the balcony inspection vent system 100 offers an easily accessible viewing port 150 to inspect the entire surface area of balcony support structure. In its closed position, the vent door 110 can be installed in line with the underside 146 of the balcony 140 to perfectly suit the thickness of the balcony for a flush finish. The mesh screen 112 in its closed position allows free circulation of air into the vent system. It also enables to release excess moisture that is retained within the balcony 140 due to flooding, inadequate sloping of the balcony 140, or other causes.

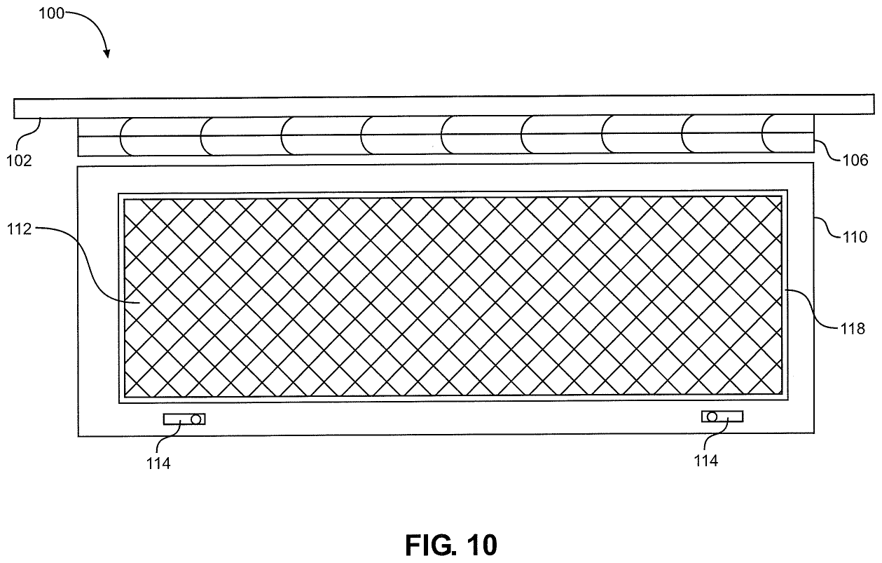

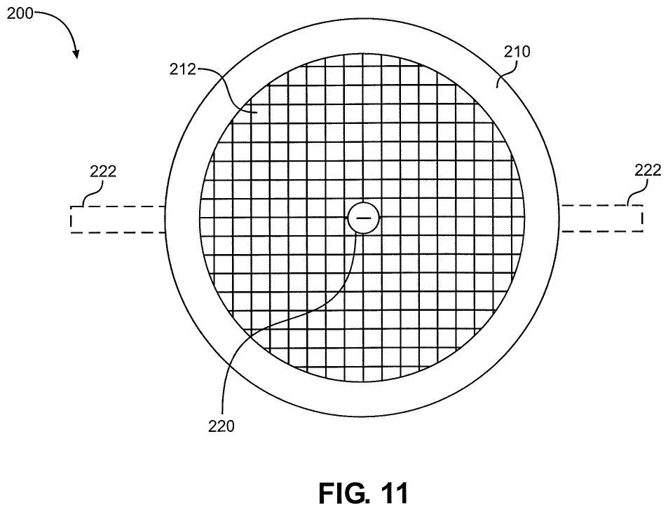

Referring now to FIG. 10, a diagram of the balcony vent door is shown to be sealed with a sealant 118, such as a sealant available commercially in the market. In a preferred embodiment, the sealant 118 is applied along the interface between the mesh screen 112 and the remainder of the vent door 110, and covers the smaller openings that surround the mesh screen 112 in the vent door 110. In doing so, the sealant 118 helps to prevent infestation by bees, wasps, termites and other insects from entering the balcony inspection vent system 100.

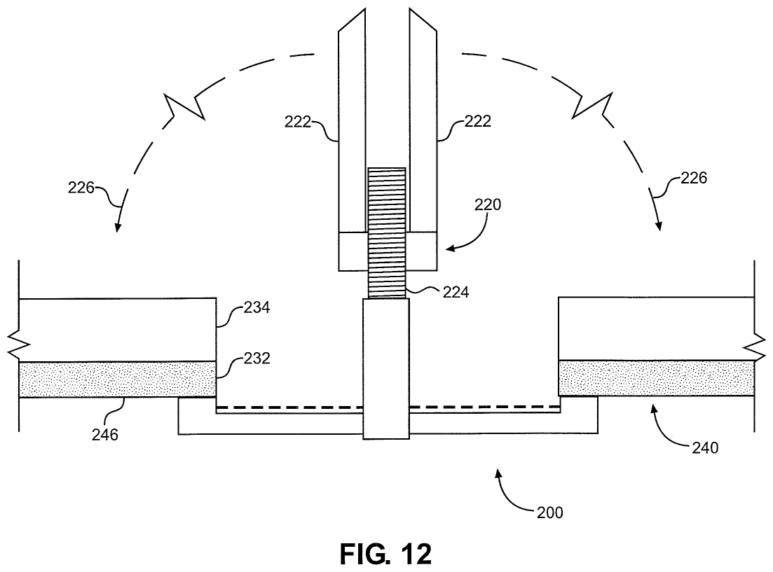

Referring now to FIG. 11, a balcony inspection vent system may be provided in various shapes, such as the circle-shaped balcony inspection vent system 200. As with other embodiments, balcony inspection vent system 200 has a vent door 210 and insect screen (or mesh) 212. Balcony inspection vent system 200 is shown secured by a toggle screw lock 220 having wings 222 that brace against the interior of the balcony 240 (shown in FIG. 12) when open, although latches such as handles 114 may be also be used, either in place of or in addition to toggle screw lock 220, to secure the balcony inspection vent system 200 in a closed configuration. It is fully contemplated that a toggle screw lock 220 may also be used in other embodiments of a balcony inspection vent system, including the rectangular embodiments described above.

Referring now to FIG. 12, toggle screw lock 220 has a bolt 224 and wings 222. Toggle screw lock 220 can be engaged from the surface of balcony inspection vent system 200 outside the balcony 240 in order to spread the wings 222 outward as indicated by directional arrows 226, resulting in a secured configuration, or to close the wings 222 into the unsecured configuration depicted in FIG. 12. The unsecured configuration allows for placing the balcony inspection vent system 200 into its open configuration, in this case by removing the vent door 210 and screen 212, as well as for replacing the vent door 210 and screen 212 as part of placing the balcony inspection vent system 200 into its closed configuration.

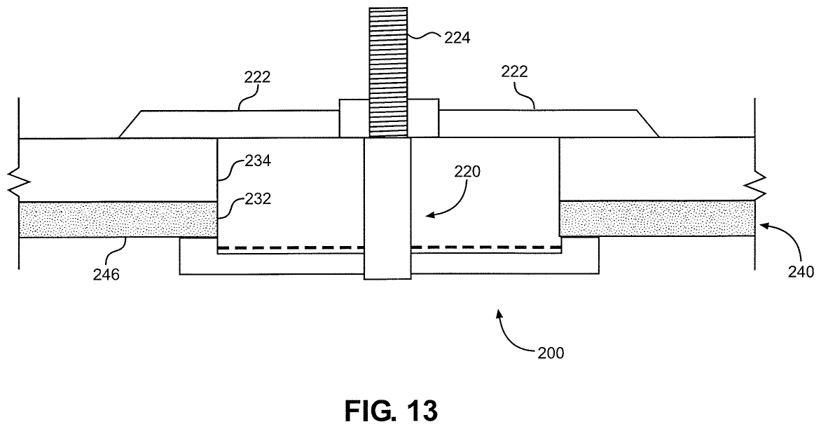

Referring now to FIG. 13, balcony inspection vent system 200 is shown in its closed configuration, with toggle screw lock 220 in its secured configuration. In the closed configuration of balcony inspection vent system 200, the vent door 210 is secured against the underside 246 of a balcony 240, shown here by way of example as being the outside of a stucco layer 232 on the outer side of a wall board backing 234. In this configuration, the wings 222 of the toggle screw lock 220 are spread out against the interior of balcony 240, shown here as the inner surface of wall board backing 234, thus removably securing the vent door 210 and screen 212 to the balcony 240.

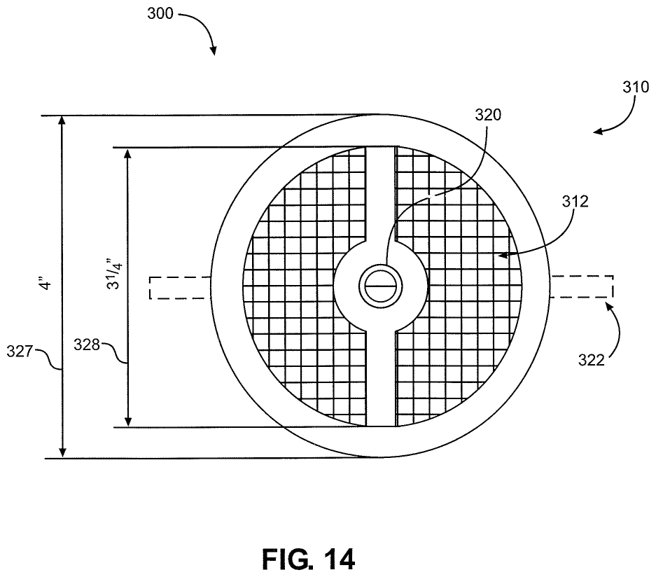

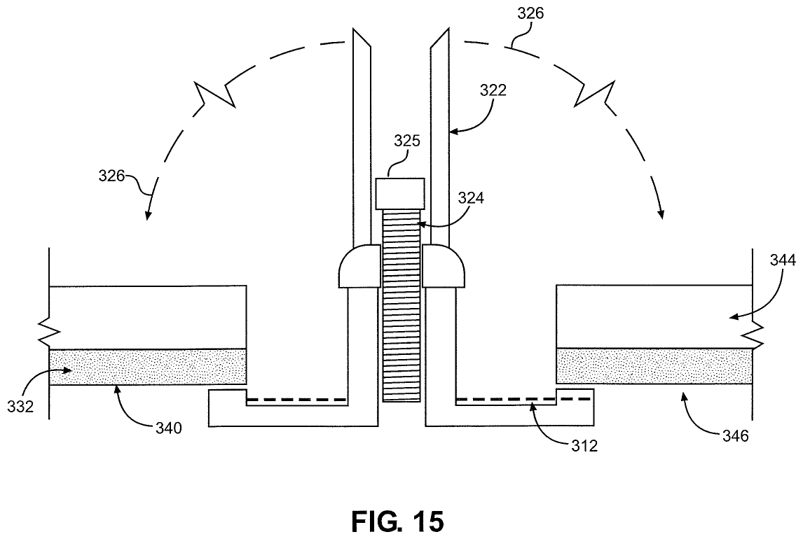

Referring now to FIG. 14, a preferred embodiment of a balcony inspection vent system is illustrated and generally designated 300. Balcony inspection vent system has a circle-shaped vent door 310 with an insect screen (or mesh) 312 divided into two parts by the frame of the vent door 310. The frame of vent door 310 surrounds the perimeter of vent door 310, and further crosses a diameter of vent door 310, with an opening providing access to toggle a toggle screw lock 320 in the center of vent door 310. Vent door 310 is secured to balcony 340 (shown in FIG. 15) by toggle screw lock 320, which has wings 322 that brace against the interior of balcony 340 when open. Some embodiments use latches such as handles 114 in place of or in addition to toggle screw lock 320 in order to secure the balcony inspection vent system 300 in a closed configuration.

In a preferred embodiment, vent door 310 has a radius 327 of four (4) inches, and insect screen has a radius 328 of three and a quarter (3¼) inches. Radius 328 is approximately equal to the aperture in the underside 346 of balcony 340 that vent door 310 covers. An overall radius 327 of four (4) inches with an internal radius 328 of insect screen 312 and the aperture in the underside 346 of balcony 340 of three and a quarter (3¼) inches is sufficient to allow for visual inspection of the internal structure of balcony 340 without the aperture interfering with supporting joists or other internal structure of balcony 340.

Referring now to FIG. 15, toggle screw lock 320 has a bolt 324, a retention ring 325, and wings 322. Toggle screw lock 320 can be engaged from the surface of balcony inspection vent system 300 outside the balcony 340 in order to spread the wings 322 outward as indicated by directional arrows 326, resulting in a secured configuration, or to close the wings 322 into the unsecured configuration depicted in FIG. 15. The unsecured configuration allows for placing the balcony inspection vent system 300 into its open configuration, in this case by removing the vent door 310 and screen 312, as well as for replacing the vent door 310 and screen 312 as part of placing the balcony inspection vent system 300 into its closed configuration.

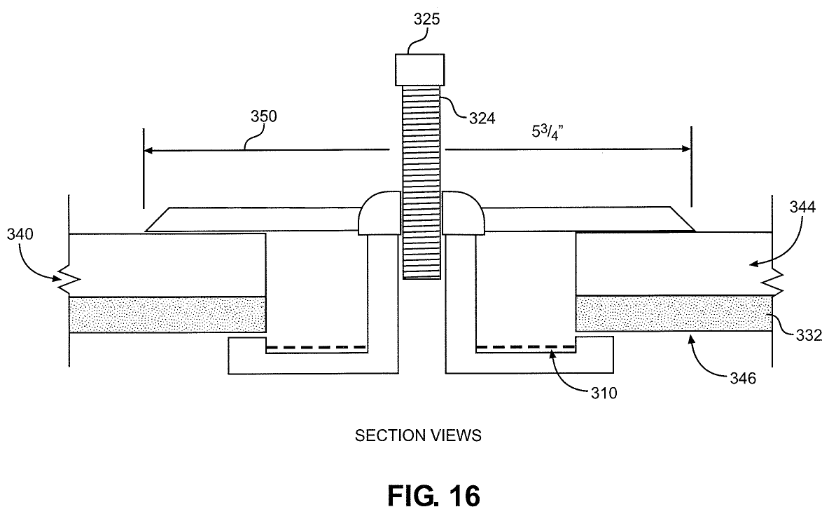

Referring now to FIG. 16, balcony inspection vent system 300 is shown in its closed configuration, with toggle screw lock 320 in its secured configuration. In the closed configuration of balcony inspection vent system 300, the vent door 310 is secured against the underside 346 of a balcony 340, shown here by way of example as being the outside of a stucco layer 332 on the outer side of a wall board backing 334. In this configuration, the wings 322 of the toggle screw lock 320 are spread out against the interior of balcony 340, shown here as the inner surface of wall board backing 334, thus removably securing vent door 310 and screen 312 to the balcony 340. In a preferred embodiment, wings 322 have a span 350 of approximately five and three quarters (5%) inches when open in the secured configuration of toggle screw lock 320. This span 350 allows the balcony inspection vent system 300 to be securely attached to the balcony 340.

While there have been shown what are presently considered to be preferred embodiments of the present invention, it will be apparent to those skilled in the art that various changes and modifications can be made herein without departing from the scope and spirit of the invention.

What is claimed is:

1. A balcony inspection vent, comprising:
a vent door;
a screen on the vent door; and
securing means for alternating the vent door between an open configuration and a closed configuration,
wherein the open configuration allows for visual access to the internal structure of a balcony, and
wherein the vent door is secured against the underside of a balcony in the closed configuration.

2. The balcony inspection vent as recited in claim 1, wherein the vent door comprises a circular shape.

3. The balcony inspection vent as recited in claim 2, wherein the securing means comprises a toggle screw lock.

4. The balcony inspection vent as recited in claim 3, wherein the open configuration comprises removal of the vent door and the screen from the balcony.

5. The balcony inspection vent as recited in claim 3, wherein the toggle screw lock comprises wings that are spread out against the interior of the balcony to secure the vent door to the balcony in the closed configuration, and wherein the wings are closed to place the vent door in the open configuration.

6. The balcony inspection vent as recited in claim 1, further comprising:
a frame;
T-shaped rods configured to attach the frame to the balcony; and
a hinge connecting the vent door to the frame.

7. The balcony inspection vent as recited in claim 6, wherein the securing means comprises two handles comprising apparatus for maintaining the vent door in the closed configuration.

8. The balcony inspection vent as recited in claim 6, wherein the T-shaped rods are positioned to attach the frame to supporting joists of the balcony.

9. The balcony inspection vent as recited in claim 6, wherein the vent door is flush with the balcony in the closed configuration.

10. A balcony inspection vent, comprising:
a vent door;
a screen on the vent door; and
a toggle screw lock attached to the vent door and having a secured configuration with wings spread outward to hold the vent door in place on a balcony, and an unsecured configuration with the wings closed to allow removal of the vent door from the balcony.

11. The balcony inspection vent as recited in claim 10, wherein the closed configuration comprises the wings of the toggle screw lock spread out against an inner surface of a wall board backing of the balcony, and the vent door secured against an underside of the balcony on the outside of a stucco layer.

12. The balcony inspection vent as recited in claim 10, further comprising handles for further securing the vent door in the closed configuration.

13. The balcony inspection vent as recited in claim 10, wherein the vent door comprises a circular shape.

14. The balcony inspection vent as recited in claim 10, wherein the open configuration allows visual access to the internal structure of the balcony.

15. The balcony inspection vent as recited in claim 14, wherein the open configuration allows access to open stud bays for inspecting the structural integrity of the balcony.

16. A balcony inspection vent, comprising:
a vent door having a circular shape;
a screen on the vent door; and
a toggle screw lock on the vent door, the toggle screw lock comprising a bolt and wings,
wherein the vent door comprises an open configuration allowing for visual access to the internal structure of a balcony, and a closed configuration securing the vent door against the underside of a balcony.

17. The balcony inspection vent as recited in claim 16, wherein the closed configuration comprises the wings of the toggle screw lock spread out against an inner surface of a wall board backing of the balcony, and the vent door secured against an underside of the balcony on the outside of a stucco layer.

18. The balcony inspection vent as recited in claim 16, wherein the open configuration allows access to open stud bays for inspecting the structural integrity of the balcony.

19. The balcony inspection vent as recited in claim 16, further comprising handles for further securing the vent door in the closed configuration.

20. The balcony inspection vent as recited in claim 16, further comprising a sealant along an interface between the vent door and the screen.
